(19) United States
(12) Patent Application Publication
(10) Pub. No.: US 2007/0239390 A1
(43) Pub. Date: Oct. 11, 2007

(54) Low-power dissipation and monitoring method and apparatus in a measurement system

(76) Inventors: Janet L. Yun, Santa Clara, CA (US); Eric N. Berseth, Santa Clara, CA (US); Nhan T. Nguyen, San Jose, CA (US); Haydee C. Trujillo, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/390,618

(22) Filed: Mar. 28, 2006

(51) Int. Cl. G06F 19/00; G06F 7/40

(52) U.S. Cl. 702/121; 702/108

(57) ABSTRACT

A measurement system and a method of configuring and gathering data are described.

### BACKGROUND

Optical interferometers are useful in exacting precise measurements. For example, optical interferometers are used to determine movement of optical elements used in photolithographic processing of semiconductor wafers, where precision on the order of nanometers (10⁻⁹ m) and greater is desired.

Optical interferometers include two (or more) optical beams. One optical beam is ideally directed along a fixed optical path length, known as the reference path. This beam is known as the reference beam. Another optical beam is directed along a path to a measurement reflector that is connected to an element that may move. This beam is known as the measurement beam, and the path it traverses is known as the measurement path.

The reference beam and measurement beam are recombined and any differential in phase is measured, normally as a beat frequency. The purposeful differential in the frequency of the beams from the light source provides a baseline beat frequency or differential. Using known signal processing techniques, it is possible to ascertain differentials in measured and reference paths (OPLs) and measure the change in the position of the measurement reflector.

The set-up and data gathering of an interferometer normally requires one or more circuit boards that include various components to perform the set-up, data gathering and data processing. In addition, diagnostic electronics is often needed during set-up and operation of the interferometer. In known systems, the set-up, diagnosis and data processing often requires physical contact (e.g., via a probe), or custom application software. The former requirement is normally for diagnosing or trouble-shooting during set-up and operation. Often, this requires that system (master and slave) boards be in close proximity to an oscilloscope, or other test equipment. The latter requirement is normally useful in performing the set-up, gathering data and diagnosis. As will be appreciated, the need to provide custom application software as well as to display data in a readable format is less than user-friendly.

In addition to the noted shortcomings of known interferometer systems and their attendant electronics, set-up of the system boards often require a controller on the board. For example, a Versa Module Eurocard (VME) bus may be used to set-up the board. The VME bus interfaces with a dedicated VME controller on the board. In addition to increasing the complexity of the board, such architectures also do not foster ease-of-use.

In addition to adding complexity to the system boards, known interferometer systems often have significant cooling requirements. As can be appreciated, the presence of a power supply circuits, an avalanche photodetector (APD), a controller or other microprocessor, and similar components on the board increases power consumption and joule heating of the system board and requires addition heat mitigation.

There is a need for a system and method in an interferometer that overcomes at least the shortcomings described above.

Defined Terminology

The terms ‘a’ or ‘an’, as used herein are defined as one or more than one.

The term ‘plurality’ as used herein is defined as two or more than two.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a simplified block diagram of a measurement system in accordance with an example embodiment.

FIG. 2 is a simplified block diagram of an external interface connected to an electronic component of a measurement system in accordance with an example embodiment.

FIG. 3A is a simplified block diagram of an external interface coupled to a microcontroller in accordance with an example embodiment.

FIG. 3B is a conceptual view of a protocol layer stack of a measurement system in accordance with an example embodiment.

FIG. 4 is a representation of a display of a web client including a graphic user interface (GUI) in accordance with an example embodiment.

### DETAILED DESCRIPTION

In the following detailed description, for purposes of explanation and not limitation, example embodiments disclosing specific details are set forth in order to provide a thorough understanding of embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

The detailed description which follows presents methods that may be embodied by routines and symbolic representations of operations of data bits within a computer readable medium, associated processors, logic analyzers, microprocessor emulators, digital storage oscilloscopes, general purpose personal computers configured with data acquisition cards and the like. A method or process is often here, and generally, conceived to be a sequence of steps or actions leading to a desired result, and as such, encompasses such terms of art as “routine,” “program,” “objects,” “functions,” “subroutines,” and “procedures.”

With respect to the software useful in the embodiments described herein, those of ordinary skill in the art will recognize that there exist a variety of platforms and languages for creating software for performing the procedures outlined herein. Certain illustrative embodiments can be implemented using any of a number of varieties of the C-programming language. However, those of ordinary skill in the art also recognize that the choice of the exact platform and language is often dictated by the specifics of the actual system constructed, such that what may work for one type of system may not be efficient on another system. In addition, in certain embodiments commercial software adapted for use with cores and other components may be implemented to realize certain beneficial aspects. Some commercial software is noted for illustrative purposes.

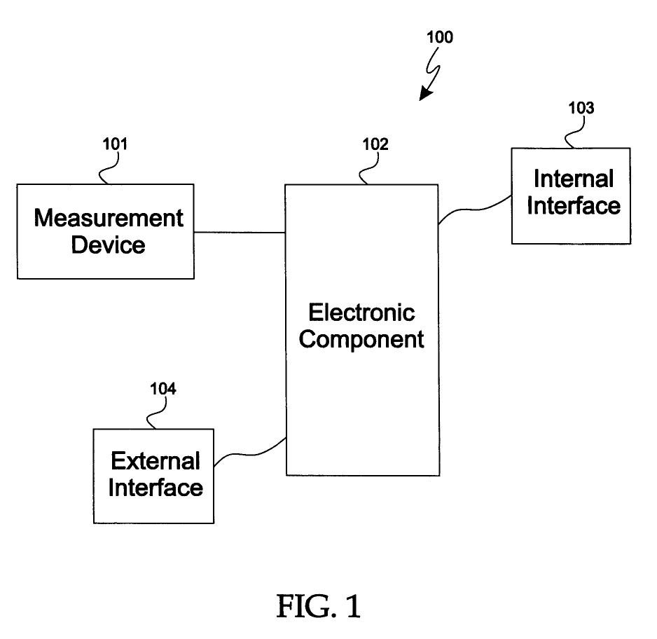

FIG. 1 is a simplified block diagram of a measurement system 100 in accordance with an example embodiment. The measurement system 100 includes a measurement device 101. In a specific embodiment, the measurement device 101 includes an optical interferometer. It is contemplated that the measurement system 101 may include other types of measurement systems known to one of ordinary skill in the art.

As is known to one of ordinary skill in the art, optical interferometers include two (or more) optical beams. One optical beam is ideally directed along a fixed optical path length, known as the reference path. This beam is known as the reference beam. Another optical beam is directed along a path to a measurement reflector that is connected to an element that may move. This beam is known as the measurement beam, and the path it traverses is known as the measurement path. In many optical interferometers the reference beam and the measurement beam have linear polarization states that are orthogonal to one another (orthonormal direction vectors). Moreover, the frequency of the orthogonal polarization states is purposefully different. The orthogonality of the polarization states allows for the separation of the light from a light source (e.g., a laser head) into the measurement and reference beams, which traverse different optical paths. The orthogonality of the linear polarization states also allows for the recombining of the reference and measurement beams after traversal of their respective light paths.

Once recombined, any differential in phase is measured, normally as a beat frequency. The purposeful differential in the frequency of the beams from the light source provides a baseline beat frequency. Using known signal processing techniques, it is possible to ascertain differentials in measured and reference optical path lengths (OPLs) and to measure the change in the position of the measurement reflector. In many interferometers there are four (4) coordinate axes, and measurements made for the position of each.

The output of the measurement device 101 is provided to an electronic component 102. The electronic component 102 includes electronics useful in calculating the coordinate position along each measurement axis. In certain measurement systems the electronic component 102 comprises a number of circuit boards, such as a master board and a plurality of slave boards. Multiple channels are measured and converted to stage position using a phase accumulator. When more boards are needed, a reference phase is passed from the master board to each of the slave boards. Each board is adapted to provide a similar function, including calculating coordinate positions. Other details of the electronic component 102 are provided herein. It is emphasized that the use of multiple circuit boards is illustrative of an embodiment. Notably, the electronic component 102 may comprise a plurality of other electronic structures to carry the same function. For example, a plurality of multichip modules (MCMs) configured and connected as described here may be used. Still other electronic structures are contemplated.

The system 100 also includes an internal interface 103. In a specific embodiment, the internal interface is a VME interface 103. The internal interface 103 may be a dedicated workstation or personal computer (PC) useful in configuring the electronic component 102 as well as other components of the system 101. Many of the details of the internal interface 103 are provided herein.

In addition to the internal interface 103, the system 100 includes an external interface 104. The external interface may be one of a variety of web clients useful in interfacing with the electronic component 102 and thus the measurement device 101. It is contemplated that the external interface 102 is not strictly a dedicated interface, but rather is a web client useful in many other applications unrelated to the measurement system 100. However, the external interface 102 is configured to provide a graphic user interface (GUI) that allows the user to configure the measurement system 100 to provide certain data on a specified internet protocol address (IPA). In addition, the GUI allows the user to perform diagnosis of the measurement system 100 and specific components thereof. Beneficially, the external interface 104 does not require an oscilloscope or other measurement device to gather data and perform diagnostics on the system 100. Rather, remote configuration of the system 100, data gathering and diagnostics may be performed via the external interface 104.

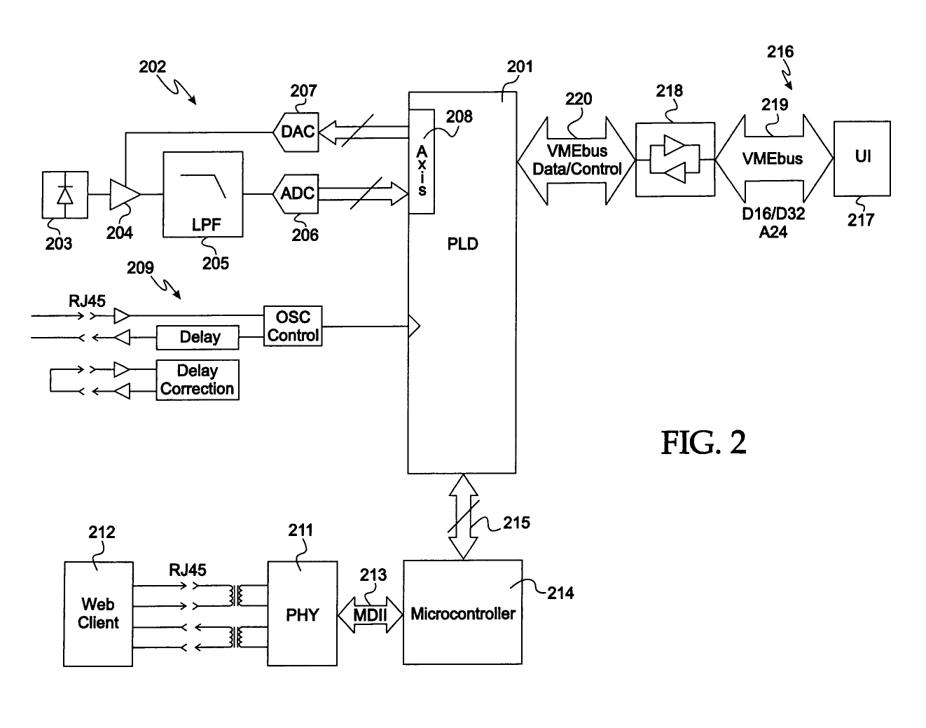

FIG. 2 is a simplified block diagram of selected components of the electronic component 102 in accordance with an example embodiment. A programmable logic device (PLD) 201 is coupled to an optical converter 202. The optical converter 202 is coupled to the optical interferometer (not shown) of the measurement device 101. The optical converter 202 includes an avalanche photodiode (APD) 203 or similar device, which provides an electrical output to an amplifier 204. The output of the amplifier 204 is filtered by a low-pass filter (LPF) 205, before being converter into a digital signal by an analog-to-digital converter (ADC) 206. In a specific embodiment, the output of the ADC 206 is via a 14 pin parallel bus to an axis input 208. The axis input 208 of the PLD 201 determines the overlap of the reflected and reference signals from the interferometer. As is known, the PLD 201 includes a plurality of axis inputs.

In an embodiment, the PLD 201 may be a field programmable gate array (FPGA). In a specific embodiment, the PLD 201 is a commercially available FPGA such as from Xilinx, Inc. The configuration of cores on the FPGA to perform certain data compiling may be carried out using Xilinx® Platform Studio software resident on the external interface 104 or on the internal interface 103.

In another embodiment, the PLD 201 may be an application specific integrated circuit (ASIC). In other embodiments, the PLD 201 may be one of a variety of known complex PLDs (CPLDs). Regardless of the specific implementation chosen, the PLD 201 is adapted to determine four coordinate axis measurements from the input channels. Illustrative methods and architectures for performing calculations using the PLD 201 with an interferometer are described in U.S. Pat. No. 6,952,175 to Chu, et al., and assigned to the present assignee. The disclosure of this patent is specifically incorporated herein by reference.

A synchronization apparatus 209 is connected to the PLD 201. The synchronization apparatus is provided to ensure that the local clock on the PLD 201, and thus the electronic component 102, is synchronized with a master clock on a master electronic component (master or mother board). The synchronization of the clock functions with the master clock is useful to ensure accurate measurement data gathering and other functions. Details of the synchronization apparatus 209 are provided in U.S. patent application Ser. No. 11/363,851, entitled “Clock Synchronization Using Early Clock” to John Flowers, et al., filed Feb. 28, 2006 and assigned to the present assignee. The disclosure of this application is specifically incorporated herein by reference.

A physical (PHY) layer 211 connects the web client 212 to a microcontroller 214 disposed on the electronic component. The microcontroller 214 in turn includes a web server implemented in known software. In a specific embodiment, the PHY layer 211 is an Ethernet (IEEE 802.3) PHY layer, which connects a web client 212 of the external interface to the microcontroller 214. The connection between the PHY 211 and the web client may be a known connection such as RJ45, or Category 5 or Category 6 (Cat5, Cat6) standards, and the connection from the PHY 211 to the microcontroller 214 may be a Medium Dependent Interface (MDI or MDIX). In an alternative embodiment, the PHY layer 211 may be a universal serial bus (USB) PHY, known to one skilled in the art.

Finally, the link of the web client 212 to the microcontroller 214 may be a wireless link or a fiber optic link. For example, a wireless link according to IEEE 802.11, or its progeny; or IEEE 802.15 (wireless personal area network (WPAN)) to include Bluetooth (IEEE 802.15.1), Zigbee (IEEE 802.15.4), and other progeny of IEEE 802.15 may be implemented. Accordingly, respective PHY layers 211 and other needed components would be implemented. It is emphasized that the noted PHY layers are merely illustrative and that other PHY layers within the purview of one of ordinary skill in the art are contemplated.

Many of the components described in connection with the embodiment of FIG. 2 are included on each of the boards (master and slave) that comprise the electronic component 102. Illustratively, each board includes the optical converter 202, the synchronization apparatus 209 and the microcontroller 214, among other components. As such, the user can access each board of the electronic component 102 via the web client 212 or the U1217, or both. Thus, the gathering of data and the configuration of each board is implemented via these interfaces.

In certain embodiments, the microcontroller 214 is a reduced instruction set computer (RISC). As is known, a RISC microcontroller is a type of microprocessor that recognizes only a limited number of instructions. As noted previously, there is a need to reduce power consumption and heating in many applications. The use of an RISC microcontroller not only reduces the power consumption by the microcontroller 214 in the system 100, but also reduces the size of the die of the integrated circuit comprising the microcontroller 214.

In a specific embodiment, a Virtex 90 nm CMOS microprocessor may be used for the microcontroller 214. In such an embodiment, differences in threshold voltages may be realized through differential doping levels of the devices in the microprocessor in order to reduce power dissipation.

In addition to the techniques described above, reduced power consumption can be achieved by selectively programming the microcontroller 214 and thus other components of the electronic component 101 to enter a ‘sleep’ mode during periods when processing requirements are reduced. Furthermore, certain voltage regulators in the synchronization apparatus 209 (clock distribution system) have been designed to improve power efficiency and thereby reduce power consumption.

Data and commands between the microcontroller 214 and the PLD 201 are provided through dedicated buses 215 as shown. The microcontroller 214 is programmed to recognize certain commands from the PHY 211. These commands are useful in diagnostics and data gathering from the measurement device 101. For example, the commands from the PHY 211 may be to configure the PLD 201 to make certain measurements at prescribed intervals in time and to display the data from the measurements at respective specified IP addresses. Thus, through the GUI on the web client 212, the user may select certain desired measurements and the IP addresses for the data from each measurement. The PHY 211 provides commands for the desired configuration to the microcontroller 214, which in turn configures the PLD 201 to make certain measurements via the measurement device 101.

In addition to configuring the PLD 201 for data gathering, the web client 212 allows the user to perform certain diagnostics on the measurement device 102. For example, during initialization of the measurement device 102, it may be useful to perform diagnostics to calibrate the measurement device 102. The web client 212 provides the GUI to select certain calibration functions. These are provided to the microcontroller 214, and implemented by the PLD 201. Furthermore, in-test diagnosis may be carried out. Additional details of remote configuration and diagnosis of the measurement system 101 in accordance with the present teachings are provided herein.

In an embodiment, the microcontroller 214 includes a known operating system (OS), with specific application code adapted to recognize and implement commands from the web client 212. A standard command-based packet protocol such as a transmission control protocol (TCP or TCP/IP) may be used over the OS link. In an embodiment, certain packets above the TCP protocol may be defined to configure the microcontroller 214. These packets may include configuration and diagnosis commands. Notably, the TCP format of the present embodiment is a separate format from the web interface commands, file transfer commands and similar TCP commands of the system 100. In specific embodiments, the TCP format may be clear text over TCP, while in other embodiments the TCP format used may be encrypted.

It is emphasized that other protocols adapted to run on top of IP networks may be used. For example, the user datagram protocol (UDP) may be used. Like the TCP/IP protocol of the example embodiments, certain packets above the UDP protocol may be defined to configure the microcontroller 214. As will be understood, the use of the UDP protocol may provide more rapid data acquisition.

The web client 212 and PHY layer 211 provide the external interface 104 of the example embodiments. Beneficially, the external interface allows the user to configure the system 100 to perform certain measurements, to perform certain diagnostics and to provide data at specified IP addresses for further review and analysis. As will be appreciated by those skilled in the art, the embodiments according to the present teachings may be implemented over known area networks (e.g., LANs, WANs) and thereby provide flexibility of taking measurements and trouble-shooting problems during testing to the user. By contrast, many known systems would require the use of a measurement device in direct contact with the electronic component to gather data and trouble-shoot problems.

In an embodiment, the internal interface 103 is implemented as a VME interface 216. The VME interface 216 includes a user interface (UI) 217 connected to bus drivers 218 via a VME bus 219. The bus drivers 218 are connected to the PLD 201 via another VME bus 220 that includes a data bus and a control bus. The internal interface 216 is useful in carrying out configuration of the PLD 201 as well as gathering measurement data and diagnostic information. However, the internal interface 103 may also be used to configure the microcontroller 214 for use by the web client 212.

In a specific embodiment, the VME bus 219 to the U1 217 includes a P1 bus and a P2 bus, which are known to one of ordinary skill in the art. A P1 connector and a P2 connector are used to make the connections to the P1 bus and P2 bus, respectively. The P1 connector is dedicated and the P2 connector is partially defined for VME bus access, with user-defined pins. The VME bus provides a comparatively high-speed interface allowing the user at the UI 217 to provide information such as IP addresses to the microcontroller 214.

The VME interface 216 is adapted to configure various components on the electronic component 101 as well as settings of the web client 212. For example, the VME interface 216 is adapted to configure the PLD 201. In a specific embodiment, the VME interface 216 is adapted to configure cores on the FPGA using software referenced previously. Illustratively, this configuration may be done during the initial configuration of the system and to update the configuration as needed.

In addition, the VME interface 216 can configure the external interface 104 to access the microcontroller 214 and thus data from the measurement system 100. In particular, it may be useful to initially configure the external interface 104 to access data using the VME interface 216, or to reconfigure the external interface 104 as needed. In an embodiment, the VME interface sets the various IP address settings for data, host settings and other network settings that may be used by the external interface 104 during operation.

During the configuration of the microcontroller 214 for the external interface 104 by the VME interface 216, the PLD 201 acts as a conduit between the VME bus 220 and the microcontroller 214. In a specific embodiment, the VME interface 216 provides the IP address to which the external interface 214 responds; provides the host name for the microcontroller 214 and other similar internet settings; sets the netmask; and dynamically assigns IP addresses via the web server using a dynamic host configuration protocol (DHCP), or assigns the IP addresses using a static protocol.

In addition to configuring the external interface 104, the VME bus 220 includes protocols connecting the bus 220 to dedicated registers on the PLD 201 that are not normally controlled by the microcontroller 214. For example, the VME interface 216 may issue a command to enable an axis of the measurement system 100. The VME bus 220 provides a command to a register of the PLD 201 (e.g., a register of the FPGA) to enable the axis. This may be done independently of the microprocessor 214.

As noted, the external interface 104 allows the user to dynamically configure the measurement system in a remote manner and in a user-friendly manner. Presently, some of the functions that may be implemented by the user via the external interface are described. It is emphasized that these are merely illustrative and that other functions are contemplated. In the interest of simplicity of description, the external interface 104 is an Ethernet interface that includes a known operating system, with application software written for the interfacing between the microcontroller 214 and the web client 212. Also, commands are via TCP/IP packets noted previously.

In an embodiment, it may be useful to measure the optical input signal strength, position, position, phase, temperature and various board voltages. Many of these data are obtained by the PLD 201 using methods described in the incorporated patent to Chu, et al. and are not repeated. The web client 212 includes a GUI adapted to include a selection menu for each of the parameters desired as well as an IP address for each parameter. Thereby, after configuring the microcontroller to ascertain the desired data from the PLD 201, the data are provided at its dedicated address for retrieval by the user. As will be appreciated, rather than having to gather many of these data with an oscilloscope via targets on the electronic component 101, the user can retrieve these data remotely via the web client 212.

In addition to gathering data, the user may remotely configure the microprocessor 214 to issue an alarm if a preset threshold is met. Using a menu on the GUI of the web client 212, the user may specify a particular alarm threshold to be displayed at an IP address. The microcontroller 214 would provide commands to the PLD 201 to provide data if an alarm threshold is met. If the threshold is met, the PLD 201 provides the data from the event to the microcontroller 214, which provides the data to the designated IP address.

In a similar manner, the user may desire to capture certain trigger events over time. The user would provide the desired parameters in the GUI of the web interface 212 and specify the IP address (es) for data. For example, if the x-position of the component under measure moves, the microcontroller 214 may be configured to command the PLD 201 to provide the data of the x-coordinate every 5 Its. These data would be gathered and provided to the IP address designated by the user, and further compiled as desired. In specific embodiments, the capture of data over time may be via sampling, such as described above, or by continuous streaming of the data to the dedicated IP address.

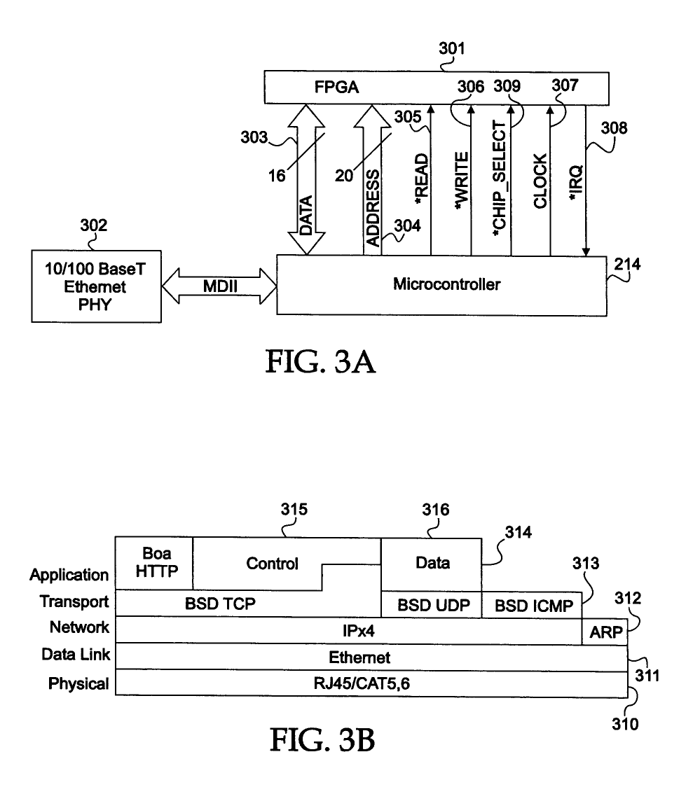

FIG. 3A is a simplified block diagram of selected components of the electronic component 102 in accordance with an example embodiment. Many details of the components of FIG. 3A are provided in the description of FIGS. 1 and 2. These details are not repeated to avoid obscuring the presently described embodiments.

In a specific embodiment, the microcontroller 214 connects a 10/100 Base T Ethernet PHY 302 to an FPGA 301. The microcontroller 214 includes a 16 bit data bus 303 and a 20 bit address bus 304. As will be appreciated, the data bus 303 and address bus 304 are useful in the configuration and function of the FPGA and its interaction with the PHY 302. When the microcontroller reads and writes the contents of a memory location or register within the FPGA 301, the address bus pins are set appropriately and receives and transmits the contents on the data bus 304. The microcontroller 214 also includes a read line 305, a write line 306, and a clock output 307. The functions of the read and write lines 305, 306 are well known and thus not described in significant detail. The clock output 307 generated by clock control circuits within the microcontroller 214.

The microcontroller 214 includes an interrupt request line (IRQ) 308 to provide IRQ values as needed for interrupts. Finally, the microcontroller 214 includes a chip select line 309. The chip select line is useful during configuration and operation to allow the microcontroller 214 to select certain components on the electronic component 101 via the FPGA 401.

FIG. 3B is a conceptual view of an Ethernet stack in accordance with an example embodiment and implemented in the PHY 302. Many details of the various layers of the stack are known and thus not repeated to avoid obscuring the description of the example embodiments.

The stack includes a PHY layer 310, which is illustratively an RJ45 or CAT 5, 6 layer. The stack includes a data link layer 311, which is an Ethernet layer in the present embodiment. Above the data link layer 311 is a network layer 312 that is illustratively an IP layer with Address Resolution Protocol (ARP) that provides dynamic address mapping between an IP address and a hardware address. A transport layer 313 is above the data link layer 312 and includes a Berkley software distribution (BSD) TCP, BSD UDP and BSD Internet Control Message Protocol (ICMP). As is known, the latter protocol supports packets containing error, control, and informational messages.

An application layer 314 includes a control protocol 315 and a data protocol 316 in accordance with an example embodiment. The data and control protocols 315, 316 are provided above the transport (TCP) layer 313.

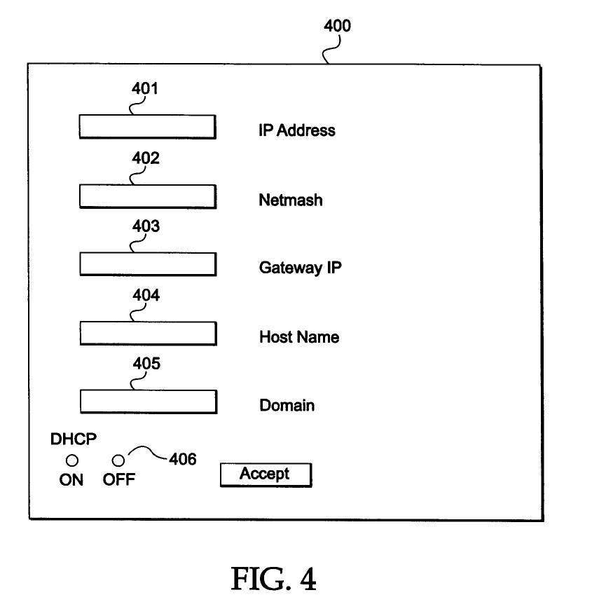

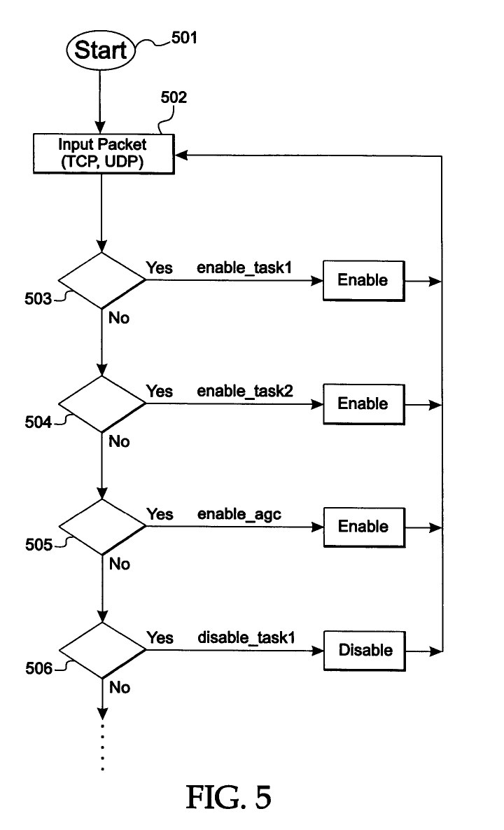

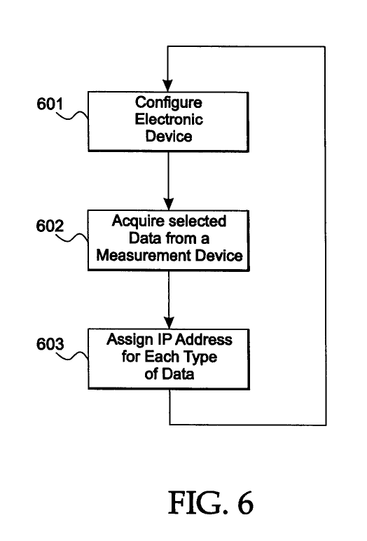

FIG. 4 is a representation of a display 400 of a web client including a graphic user interface (GUI) in accordance with an example embodiment. In the present embodiment, the display 400 shows the GUI for configuring an Ethernet interface such as the external interface 104. Naturally, other fields are provided to specify certain measurements to be taken and to designate IP addresses for data gathered.

The display includes: an IP address field 401, a netmask field 402, a gateway IP field 403, a hostname field 404 and a domain name field 405. The user may enter these fields or the fields may be stored and provided by a drop-down menu at each field. In addition, the display includes a choice between enabling DCHP or not. A selector 406 is provided as shown.

FIG. 5 is a flow-diagram showing a series of commands from the web client 212, or the VME interface 216 to the microcontroller 214. These commands may be provided during initial configuration, or calibration or operation of the measurement system 100. In the interest of simplicity of description, the enabling of automatic gain control (AGC) in the optical converter 202 is highlighted to illustrate the interaction of the interfaces 212, 216 with the microcontroller 214 and the PLD 201. Of course, many other tasks or functions may be implemented similarly.

At step 501, the process begins with the selection of fields from a menu of the GUI, such as shown in FIG. 4. At step 502, the inputs fields are encoded as packets according to the selected protocol. Illustratively, the packets may be above the TCP protocol or the UDP protocol as described previously. After the packets are formed, transmission occurs from the particular interface to the microcontroller 214. After the packet is decoded, standard comparator functions are performed. These are shown in decision diamonds 503-506. In the present illustration, the command to enable AGC is transmitted in the packets to the microcontroller and is represented as enable_AGC. At diamond 503, the comparison is between the decoded packets and ‘enable_task1’ command, previously programmed into the microcontroller 214. Thus, the decision is negative and the process continues at diamond 504. The comparison is made between the decoded packets and ‘enable_task 2’ command. The decision is again negative and the process continues at diamond 505. Here, the command is matched and the decision to enable AGC is made. This command is provided from the microcontroller 214 to the PLD 201, which in turn enables AGC. Of course, the PLD 201 has been previously configured to enable/disable AGC, likely during initial configuration as noted previously.

Diamond 506 represents the comparison of a command ‘disable_task1.’ If this command is received, the particular task is disabled. As will be appreciated, for each enable command, there is likely a counterpart diable command.

FIG. 6 is a flow chart of a method in accordance with an example embodiment. At step 601, the method includes configuring an electronic device on the electronic component 102. In keeping with embodiments described previously, microcontroller 214 may be configured remotely via the web client 212, or the VME interface 216, or both, via the protocols described previously. In turn the microcontroller 214 may configure the electronic device, which may be the PLD 201.

At step 602, selected data are acquired from the measurement device. These data may be position, temperature, optical power or other types of data noted previously. Furthermore, the acquiring of the data by the electronic device may be carried out according to the incorporated teachings of Chu, et al.

At step 603, the microcontroller 214 assigns an IP address for each type of data. When the data are acquired, the PLD 201 provides the data to the web client 212 via the microcontroller, or to the VME interface 216.

In accordance with illustrative embodiments described, an interferometer is useful in measurement systems. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. A measurement system, comprising:
a measurement device;
an electronic component adapted to gather data from the measurement device;
an external interface adapted to configure an electronic device on the electronic component to command the measurement device to perform selected measurements and to command the electronic component to gather data.

2. A measurement system as claimed in claim 1, Wherein the external interface is connected to a microcontroller of the electronic component, and the niicrocontroller is adapted to receive commands from the external interface and to configure the electronic device based on the commands.

3. A measurement system as claimed in claim 1, wherein the external interface is connected to a microcontroller of the electronic component, and the microcontroller is adapted to receive commands from the external interface and to configure the electronic device based on the commands, and to perform diagnostic tests based on the commands.

4. A measurement system as claimed in claim 1, wherein the external interface is an Ethernet link.

5. A measurement system as claimed in claim 1, wherein the external interface is a wireless link.

6. A measurements system as claimed in claim 1, wherein the measurement device is an optical interferometer.

7. A measurement system as claimed in claim 1, further comprising an internal interface adapted to configure the electronic device on the electronic component to command the measurement device to perform selected measurements and to command the electronic component to gather the data.

8. A measurement system as claimed in claim 7, wherein the internal interface is a Versa Module Eurocard (VME) bus interface.

9. A measurement system as claimed in claim 1, wherein each of the selected measurements is provided to a specific internal protocol (IP) address adapted for access by the external interface.

10. A measurement system as claimed in claim 1, wherein the electronic device is a programmable logic device (PLD).

11. A measurement system as claimed in claim 10, wherein the PLD is a field programmable gate array (FPGA), or an application specific integrated circuit (ASIC).

12. A measurement method, comprising:
configuring an electronic device on an electronic component of a measurement device via a web client; and
acquiring selected types data from the measurement device at the electronic component; and
assigning an internet protocol (IP) address for each selected type of data.

13. A measurement method as claimed in claim 12, wherein the web client is connected to the electronic device via an Ethernet link.

14. A measurement method as claimed in claim 1, wherein the web client is connected to the electronic device via a wireless link.

15. A measurement method as claimed in claim 1, wherein the configuring further comprises:
transmitting commands from the web client to a microcontroller;
transmitting the commands from the microcontroller to a programmable logic device (PLD) of the electronic component.

16. A measurement method as claimed in claim 15, wherein the commands are commands to perform certain measurements, or to gather data based on selected measurements, or both.

17. A measurement method as claimed in claim 15, wherein the commands are diagnostic commands.

18. A measurement method as claimed in claim 15, further comprising selectively entering a sleep mode to reduce power consumption.
